(19) United States
(12) Patent Application Publication
(10) Pub. No.: US 2016/0267057 A1
(43) Pub. Date: Sep. 15, 2016

(54) SYSTEM AND METHOD FOR CREATING AND PRESENTING RICH MEDIA PROFILES

(71) Applicant: ZeeMee, Inc., Redwood City, CA (US)

(72) Inventors: Adam M. Metcalf, San Mateo, CA (US); Peter J. Huitsing, Belmont, CA (US); Adam A. Cruz, Redwood City, CA (US); Juan Jaysingh, Mountain View, CA (US)

(21) Appl. No.: 15/062,803

(22) Filed: Mar. 7, 2016

Related U.S. Application Data
(60) Provisional application No. 62/129,718, filed on Mar. 6, 2015.
(60) Provisional application No. 62/140,669, filed on Mar. 31, 2015.

(51) Int. Cl. G06F 17/21

(52) U.S. Cl. CPC G06F 17/212

(57) ABSTRACT

The present disclosure includes a system useful for serving online applications for applicants applying for admission into an institution such as, for example, a school, college, university, academy, corporation, etc. or for selection of a scholarship. The system includes a computer store and a computer server coupled to the computer store. The computer store containing data for a web page of the applicant that includes rich media elements such as, for example, images, video, text, links to documents, new stories, etc. The computer server is programmed to generate an application for the applicant that includes the rich media elements and to send the application to the institution.

### CROSS REFERENCE TO RELATED APPLICATIONS

This application claims priority to and the benefit of U.S. Provisional Patent Application No. 62/129,718, filed 6 Mar. 2015, and U.S. Provisional Application No. 62/140,669, filed 31 Mar. 2015, the disclosure of each is now expressly incorporated herein by reference.

### FIELD OF THE DISCLOSURE

The present disclosure relates generally to systems and methods for creating and presenting rich media profiles, and more specifically to dynamic presentation of an applicant's qualifications for scholastic, athletic, and employment opportunities.

### BACKGROUND

Conventionally, an applicant seeking admissions into an institution such as, for example, enrollment in a higher education program or seeking an employment opportunity, submits a text based application and/or resume to the institution. Resumes are often limited to one page of employment history and scholastic achievements. Text based applications may allow for more than one page of text, but limit or inhibit non-text qualities of the applicant such as their personality, experience, and qualifications.

As a result, the applicant's ability to present a complete picture of their potential value to the institution may be limited and the applicant's chances of being admitted to the institution or holistically reviewed during the admissions process may be reduced. Likewise, the institution may not be admitting the best applicants due to the limitations in the text based application process. Furthermore, it may be difficult for the applicant to stand out among the monotonous applications in a typical text-based application process. As such, means to improve upon these methods would constitute useful improvements.

### SUMMARY

The present disclosure may comprise one or more of the following features and combinations thereof.

A system useful in an outsource provider serving web pages offering scholastic opportunities may include a computer store and a computer server coupled to the computer store. The computer store may contain data for each of a plurality of first web pages and a plurality of second web pages. Each of the first web pages may be associated with one of a plurality of applicants and each first web page may include a plurality of rich media elements. Each of the second web pages may be associated with one of a plurality of institutions. Each of the second web pages may display an active link associated with a scholastic opportunity of a selected on of the plurality of institutions.

The computer server may be programmed to receive from a web browser of an applicant a signal indicating activation of an active link displayed by one of the second web pages; automatically identify the scholastic opportunity associated with the activated link; automatically identify a subset of the rich media elements included in the first web page associated with the applicant, the identified subset of rich media elements being indicative of qualifications of the applicant that are associated with the scholastic opportunity; retrieve stored data corresponding to the scholastic opportunity and the identified subset of rich media elements in response to identification of the scholastic opportunity; and using the data retrieved, automatically generate and transmit to the selected institution a third web page that displays: information associated with the scholastic opportunity associated with the link that has been activated and the subset of the rich media elements.

In some embodiments, the selected institution, the outsource provider, and the applicant may each be third parties with respect to one another. In some embodiments, the subset of the rich media elements may be indicative of at least one of a scholastic, athletic, and employment qualification of the applicant associated with the first web page.

In some embodiments, each of the first web pages may be associated with a uniform resource identifier without ambiguous text characters. In some embodiments, the computer server may be further programmed to automatically identify qualifications of the applicant based on the plurality of rich media elements included in the first web page and display an active link associated with a scholastic opportunity of at least one of the second web pages on the first web page associated with the applicant in response to identifying the applicant's qualifications.

In some embodiments, the computer server may be further programmed to organize the information displayed in the third web page into a predetermined layout in response to identification of the scholastic opportunity. In some embodiments, the predetermined layout may be selected by the selected institution. In some embodiments, the computer server may be further programmed to identify a plurality of first web pages having rich media elements associated with a designated qualification and transmit a fourth web page including active links to the plurality of first web pages having rich media elements associated with the designated qualification to one of the plurality of institutions.

In some embodiments, the computer server may be further programmed to organize the information displayed in the third web page into a predetermined layout including a first rich media element, a second rich media element located below the first rich media element, and a third rich media element located below the second rich media element. The first rich media element may include a video of the applicant associated with the first web page. The second rich media element may include text and images associated with qualifications of the applicant associated with the first web page. The third rich media element may include one or more of a video, text, document, image, and a graphics interchange format image indicative of the qualifications of the applicant associated with the first web page.

According to another aspect of the present disclosure, a system useful for serving online applications may include a computer store and a computer server. The computer store may contain data for each of a plurality of first web pages. Each of the first web pages may be associated with one of a plurality of applicants. Each of the first web pages may include a plurality of rich media elements indicative of qualifications of the applicant associated with the first web page. Each of the first web pages may display an active link associated with an application for admission into one of a selected plurality of institutions. The computer server may be coupled to the computer store and programmed to: receive from a web browser of one of the applicants a signal indicating activation of the active link; automatically identify the application for admission into the selected institution associated with the activated link; automatically identify the applicant associated with the first web page; automatically identify the rich media elements included in the first web page; retrieve stored data corresponding to the application for admission into the selected institution the applicant associated with the first web page, and the rich media elements included in the first web page in response to identification of the application for admission into the selected institution; and using the data retrieved, automatically generate and transmit to the selected institution a second web page that displays: information associated with the application associated with the link that has been activated, information associated with the applicant associated with the first web page, and the rich media elements included in the first web page.

In some embodiments, the computer server may be further programmed to organize the information displayed in the second web page into a predetermined layout designated by the selected institution in response to identification of the application for admission into the selected institution associated with the activated link. In some embodiments, the computer server may be further programmed to receive from one of the selected plurality of institutions a designated qualification and to identify and provide a plurality of first web pages having rich media elements associated with the designated qualification to the selected institution.

In some embodiments, the computer server may be further programmed to organize the information displayed in the second web page into a predetermined layout including a first rich media element, a second rich media element located below the first rich media element, and a third rich media element located below the second rich media element. In some embodiments, the first rich media element may include a video of the applicant associated with the first web page. The second rich media element may include text and images associated with qualifications of the applicant associated with the first web page. The third rich media element may include one or more of videos, text, documents, images, and graphics interchange format images associated with qualifications of the applicant associated with the first web page.

According to another aspect of the present disclosure, a system may include a controller. The controller may include a processor and a memory. The memory may have stored therein a plurality of instructions that when executed by the processor cause the controller to: receive instructions to endorse the applicant from one of a plurality of references of the applicant; identify a classification of the reference of the applicant; display a plurality of qualifications for the reference to endorse the applicant as possessing; receive instructions to endorse one of the displayed plurality of qualifications from the reference; store information associated with the reference and associated with the qualification endorsed by the reference; and transmit to a computing device coupled with the controller the qualifications of the applicant that have been endorsed by the plurality of references, a weighted value of each of the qualifications based on the classification of each reference that endorsed the qualification, and a name of the references that endorsed the qualification of the applicant.

In some embodiments, the memory may be configured to store data associated with qualifications of a plurality of applicants and a plurality of references. The plurality of instructions may further cause the controller to adjust the weighted value of the endorsements of each reference based on a number of qualifications that the reference has endorsed.

In some embodiments, the plurality of instructions may further cause the controller to display a plurality of indicia. Each indicium may be associated with an endorsable qualification of the applicant.

In some embodiments, the plurality of instructions may further cause the controller to block the applicant from endorsing qualifications of the applicant. In some embodiments, the plurality of qualifications may include, but is not limited to, one or more of business savvy, creative, driven, generous, humorous, leader, outgoing, problem solver, and team player. In some embodiments, the indicia may include, but is not limited to, one or more of a briefcase, a paintbrush, a moving truck, a hand, a face, human silhouettes, a speech bubble, a calculator, and two fists.

These and other features of the present disclosure will become more apparent from the following description of the illustrative embodiments.

### BRIEF DESCRIPTION OF THE DRAWINGS

FIG. 1A shows an illustrative rich media profile web page;

FIG. 1B shows another illustrative rich media profile web page;

FIG. 2 is a flow chart for generating profile web pages formatted to an admissions standard;

FIG. 3 is a flow chart for generating tailored applicant profile web pages;

FIG. 4 is a flowchart depicting different user interfaces for a two-tier profile web page system;

FIG. 5 is a diagrammatic view of a system for endorsing traits and qualifications of an applicant; and

FIG. 6 depicts an illustrative histogram of the endorsed traits of an exemplary applicant.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

A system in accordance with the present disclosure is useful for serving online applications for applicants applying for admission into an institution such as, for example, a high school, college, university, academy, firm, company, corporation, etc. or for selection of a scholarship. In illustrative embodiments, the system includes a computer store and a computer server coupled to the computer store. The computer store contains data for a web page of the applicant that includes rich media elements such as, for example, images, video, text, links to documents, news stories, etc. The computer server is programmed to generate an application for the applicant that includes the rich media elements and to send the application to the institution via the internet.

In some embodiments, the system further includes a controller having a memory and a processor. The memory has, stored therein, a plurality of instructions that when executed by the processor cause the controller to perform a number of steps. In some embodiments, the duties of the processor are split among several computer systems. The data store may be implemented through a database system. The Internet serves as the communication link between applicant computers and the institution computers. The tasks performed by the processor may utilize a variety of underlying software technology. In some embodiments, the software architecture may be divided into 3 tiers: web server, application-server and database-server. Each tier is comprised of a number of software layers. The data store, computer server, memory, and processor may include virtual storage, cloud computing, cloud storage, etc.

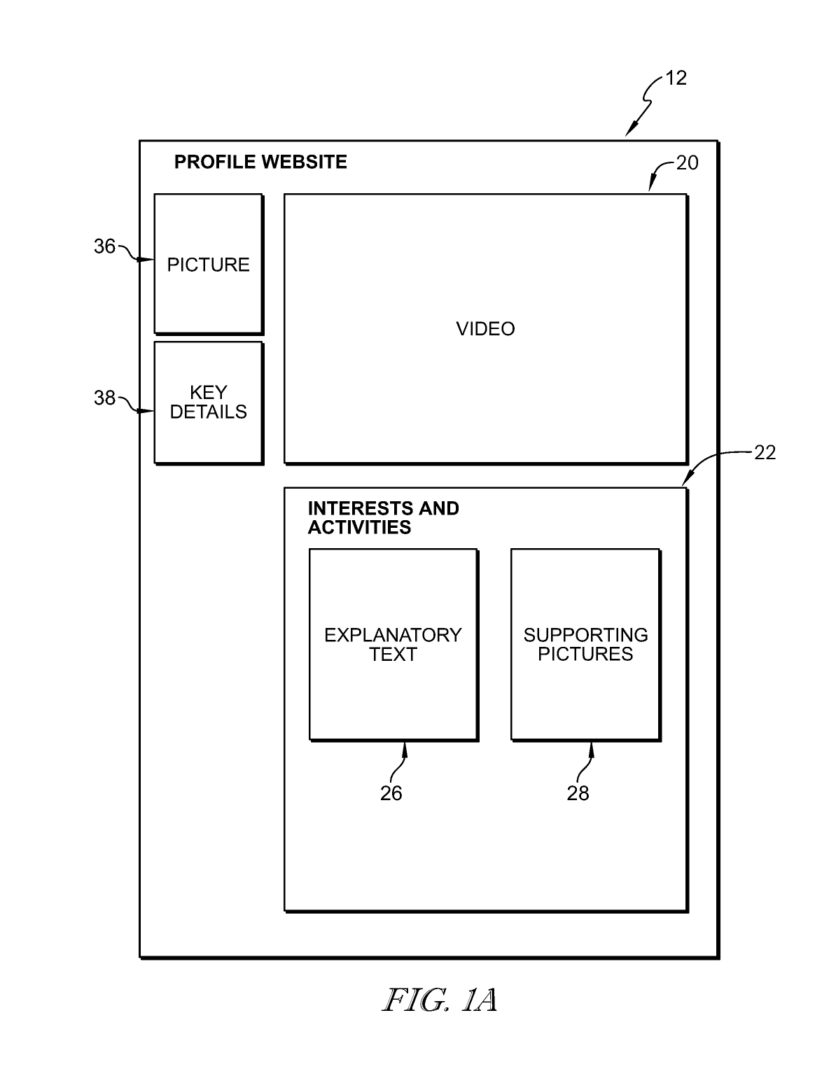

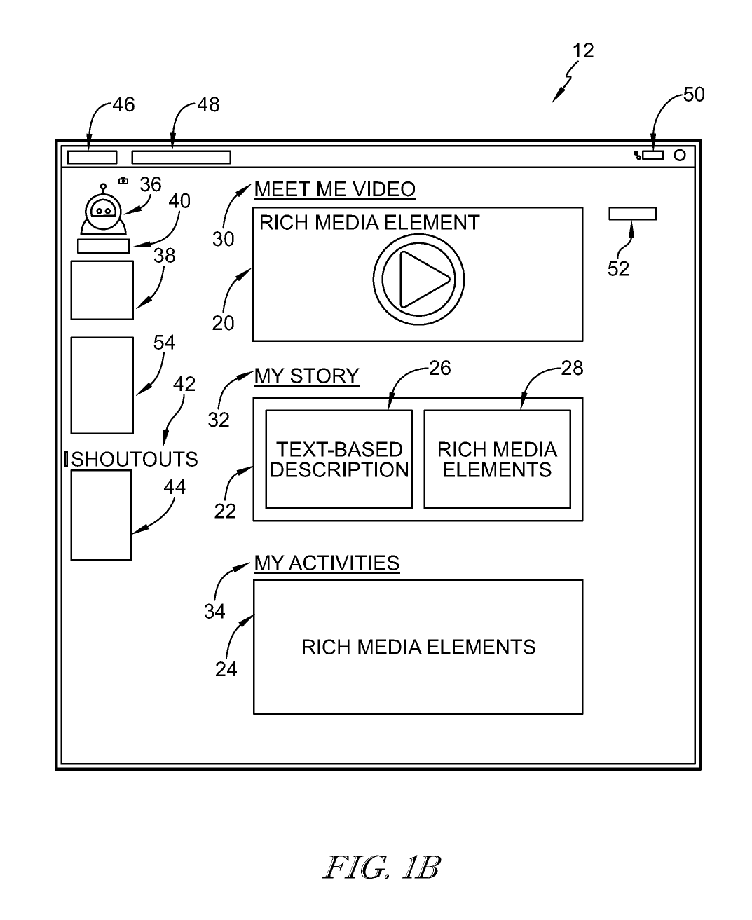

In the illustrative embodiment, an applicant uploads rich media elements 14 to a first web page 12 as suggested in FIGS. 1A and 1B. The rich media elements 14 may include videos, text, documents, images, and a graphics interchange format images. The rich media elements 14 are indicative of qualities of the applicant. In some embodiments, the rich media elements 14 may be indicative of a scholastic, athletic, or employment qualification that the applicant possesses. As an example, the rich media elements 14 may include images of the applicant performing in a sporting event or of the applicant receiving a scholastic award.

The system is configured to store information associated with a plurality of applicants and a plurality of rich media elements for each applicant. The system is further configured to store information associated with applications for admission into a plurality of institutions. The institutions may include high schools, colleges, universities, academies such as, for example, sports or dance academies, corporations and businesses. The plurality of institutions further includes organizations providing scholarships. As such, the concept of applying to an institution includes applying for a scholarship.

In illustrative embodiments, the first web page associated with the applicant includes a uniform resource identifier (sometimes called uniform resource locator) without ambiguous text characters. For example, the uniform resource identifiers may be blocked from including one or more of the characters capital 0, the number zero, lowercase L, the number one, and uppercase i. As such, the applicant may type a link address to the applicant's web page in a text-based application. In some embodiments, the applicant may copy and paste the uniform resource identifier associated with their web page into a text based app ran on an electronic device.

When reviewing an application of an applicant, an officer of the institution such as, for example an admissions counselor, may be reviewing a printed application or a photograph of the application. As such, the officer may not be able to copy and/or paste the uniform resource identifier or click/activate an active link to the applicant's web page. To receive information from the website associated with the applicant, the officer may manually type the uniform resource identifier from paper into a web browser. By limiting the uniform resource identifier associated with the first web page to unambiguous text characters, the chance of the officer entering an incorrect uniform resource identifier is reduced

### Automated Recommendations for Schools/Scholarships/Products/Services/Employment Opportunities

In an illustrative embodiment, the system analyzes the applicant's web page to provide recommendations for schools to apply to, scholarships to apply for, and any other products or services that may be relevant. In some instances this may be integrated with schools, colleges and/or scholarship provider information. For example, an applicant may include photos and videos of their involvement in dance. The system may recognize this interest in dance and match the applicant with dance scholarships that are open for applications.

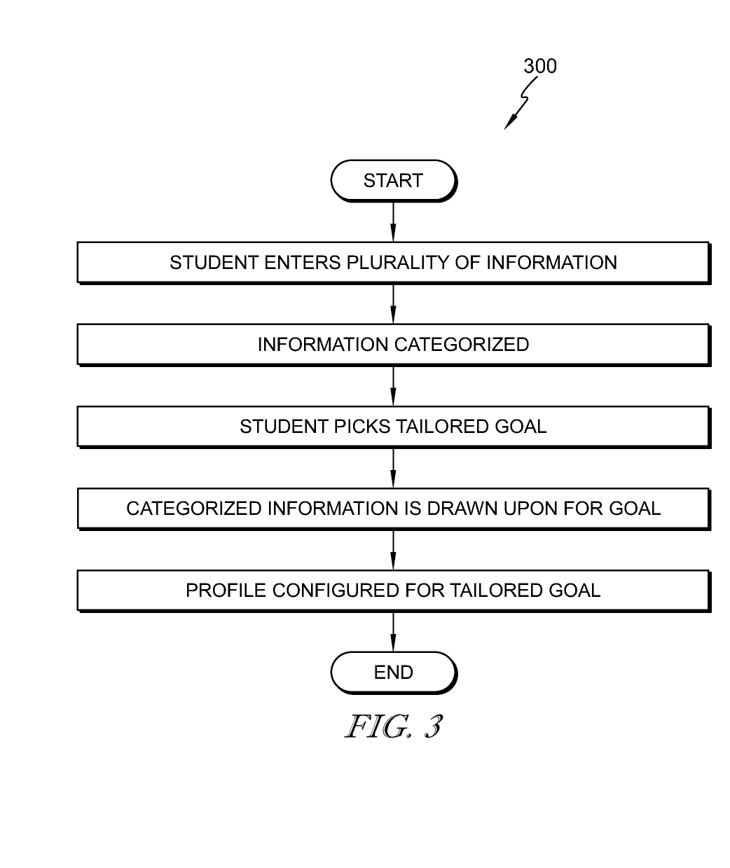

In one illustrative example, the computer server of the system is programmed to automatically identify qualifications of the applicant based on the plurality of rich media elements included in the first web page. The computer server displays an active link associated with a scholastic opportunity on the web page associated with the applicant in response to identifying the applicant's qualifications. Referring to FIG. 3, in some embodiments, the applicant chooses a tailored goal as part of a method 300. The system pulls up the categorized information on the goal and configures a web page for the applicant with rich media elements indicative of the qualities of the applicant that are associated with that tailored goal.

In some cases, recommendations may be based on the current real time needs of a college or scholarship provider. For example, a college in the middle of an applicant evaluation process may determine that it needs more qualified applicants that are interested in the arts. This identified need may be matched with the applicant's web page that includes the rich media elements of their involvement in dance and recommend to the applicant that they apply to the particular college.

In an illustrative embodiment, the computer server is programmed to identify a plurality of web pages associated with applicants that have rich media elements associated with a designated qualification such as, for example, an interest in art. The computer server is programmed to transmit a web page including active links to the plurality of applicant web pages that have rich media elements 14 associated with the designated qualification to one of the plurality of institutions.

### Continuously Built Rich Media Profile Web Page

An applicant may begin populating their profile web page during middle school or their freshman year of high school. Perhaps in much the same way that they interact with other social media. In other words, the applicant may use the web page as a platform to upload rich media elements 14 such as photos, videos, new stories, awards, etc. of their various accomplishments during their high school career as suggested in FIGS. 1A and 1B. This may even be linked up with other third party social network platforms.

At the time the applicant begins applying for colleges the system has an extensive database of information that highlights the applicant as a person and their accomplishments. This information may then either be sifted through manually to identify key components to include with applications or the system may analyze the content and automatically organize a subset of the content into a coherent, yet concise summarized profile web page.

Further, having all of this content at hand may allow the applicant to continuously update their profile page with different information. The information is then stored in the data store of the system. An applicant's profile data could extend beyond college and could eventually be used for applying to internships, scholarships, jobs, etc. Similar matching functionalities of the system would apply here.

### Tailored Profile Web Pages

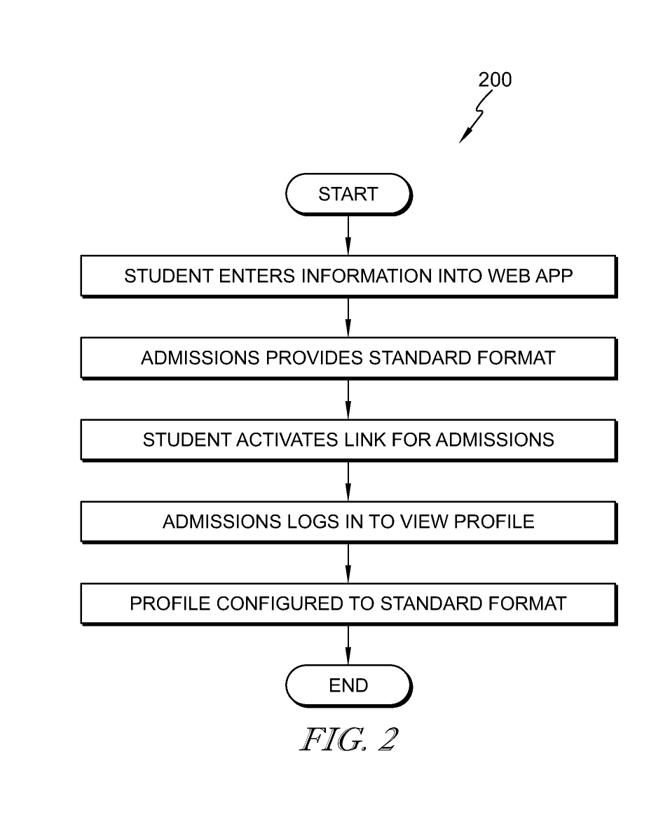

In some embodiments, profile web pages of applicants may be automatically or manually tailored based on the institution such as, for example, the school or scholarship, to which the applicant is applying as suggested in FIG. 2. For example, consider a profile with a high school career's worth of information uploaded. A given applicant could be involved in numerous activities or clubs such as football, chess club, and honors societies. As part of the method 200, the system illustratively automatically pulls content from the rich media elements 14 included the applicant's web page to populate a web page tailored for a particular application. If an applicant is applying for a sports scholarship, the system automatically pulls rich media elements 14 and information on sports awards to include in the web page tailored for that application.

Other information that is not relevant to the application may not be included in the tailored application. A video showing the applicant competing in a race would be more relevant to athletic ability than a video of the applicant negotiating in a mock trade agreement. Thus the race video would more likely appear in a tailored profile web page for an athletic scholarship. The tailored profile web page would be shorter and directed more to the particular desires of the application.

The system allows an outsource provider to serve web pages with scholastic, employment, and athletic opportunities from a plurality of institutions to a plurality of applicants. In some embodiments, information and rich media elements 14 relating to the applicant's qualifications is entered freeform into fields provided by the system and the system automatically sorts information and rich media elements 14 into categories. The summarized profile web page is generated by pulling information from the relevant categories for the tailored interest of the application.

The web pages associated with the applicants enables the applicants to showcase themselves in the admissions process, to apply for and obtain scholarships, and to access employment opportunities by creating a unique profile web page that brings each applicant's story to life. In some embodiments, the system partners with schools dedicated to a holistic review of the applicants. The schools determine a standardized format in which the applicant's qualifications are organized and presented in a second web page for the school. That standardized format would be applied to any profiles viewed by users logged in using the school's log in information. This would save time spent per applicant in large applicant pools.

Referring to FIG. 2, an illustrative system useful in an outsource provider serving web pages offering scholastic opportunities includes the computer store and the computer server. The computer store contains data for each of a plurality of first web pages associated with one of a plurality of applicants and each first web page includes a plurality of rich media elements of the applicant. The computer store further contains data for each of a plurality of second web pages associated with one of a plurality of institutions. Each of the second web pages displays an active link associated with a scholastic opportunity of a selected one of the plurality of institutions.

The computer server is coupled to the computer store and programmed to receive from a web browser of an applicant a signal indicating activation of an active link displayed by one of the second web pages. The computer server automatically identifies the scholastic opportunity associated with the activated link. The computer server automatically identifies a subset of the rich media elements included in the first web page associated with the applicant. The identified subset of rich media elements being indicative of qualifications of the applicant and that are associated with the scholastic opportunity. The computer server then retrieves stored data corresponding to the scholastic opportunity and to the identified subset of rich media elements in response to identification of the scholastic opportunity. The computer server then automatically generates and transmits to the selected institution a third web page that displays information associated with the scholastic opportunity associated with the link that has been activated and the subset of the rich media elements.

As such, an applicant can use information from one web page to apply to a plurality of institutions. Each institution receives information and qualification of the applicant that are relevant to the application of the institution. Moreover, the information and qualifications are organized per the institutions instructions in a predetermined format. In the illustrative embodiment, the institutions, the outsource provider, and the applicants are each third parties with respect to one another.

As an example, the computer server may be programmed to organize the information displayed in the web page transmitted to the institution into a predetermined layout including a first rich media element 20, a second rich media element 22 located below the first rich media element 20, and a third rich media element 24 located below the second rich media element 22 as shown in FIGS. 1A and 1B. In the illustrative embodiments, the first rich media element 20 includes a video of the applicant. The second rich media element 22 includes text 26 and images 3280 associated with qualifications of the applicant. The third rich media element 24 includes one or more of a video, text, document, image, and a graphics interchange format image indicative of the qualifications of the applicant. The first rich media element 20 may be identified as a “Meet Me Video” 30 which is a short video that showcases the applicant. The second rich media element 22 may be identified as “My Story” 32. The third rich media element 24 may be identified as “My Activities” 34.

Illustratively, the web page of each applicant further includes an image 36 of the applicant, and details 38 of the applicant such as, for example, the applicant's name 40, the city and state of the applicant, the applicant's high school, “shoutouts” 42 that include endorsements 44 of the applicant, etc. In some embodiments, the web page 12 further includes a logo 46 of the outside provider, a search bar 48, an active link 50 that provides a text based link to the applicant's web page, and an active link 52 to a selected one of a plurality of applications to one of the institutions.

### Alternative to an Essay or Writing Supplement

Some applicants prefer creating web page profiles over writing essays. In some embodiments, the profile web page of the applicant is used as an alternative to an essay in some embodiments. Such an alternative to essays is highly attractive to prospective applicants and decreases the review time spent per applicant by an admissions officer.

### Substitute for an Interview

Some applicants prefer creating web page profiles over interviews. In some embodiments, the profile web page of the applicant is used as an alternative to an in-person interview or an online interview. Such an alternative to an interview is highly attractive to prospective applicants and may decrease the review time spent per applicant by an admissions officer.

### Visual Resume

Resumes may be disorganized and difficult to follow; however, a profile web page of an applicant brings structure and visual authenticity to an applicant's story. Profile pages may be encouraged as a replacement to resumes which may save time and prepare applicants for future success.

### International Applicants

A growing number of international applicants have led to an increased need for validation and authentication of the applicant pool. In some embodiments, international applicants build a profile web page and use the web page to apply to institutions. The web page may help ensure integrity and transparency in the admissions process and increase the quality of the applicants being admitted.

### Scholarship Selection

In some embodiments, scholarship selection committees use applicant profile web pages as a holistic method to evaluate the applicant. Applicants provide information to the system prior to a personal or video interview with the selection committee. Doing so may ensure a more streamlined, focused, and efficient use of time in the interview process and may better facilitate the selection of high quality applicants.

### College Profile Page

In some embodiments, institutions submit rich media elements 14 to the system and create a web page associated with the institution. In the same way that applicants are assisted in making their applications come alive, colleges, employers, and scholarship providers can express their message and paint a picture of how they want to be seen.

### Connecting Admissions Teams with Applicants

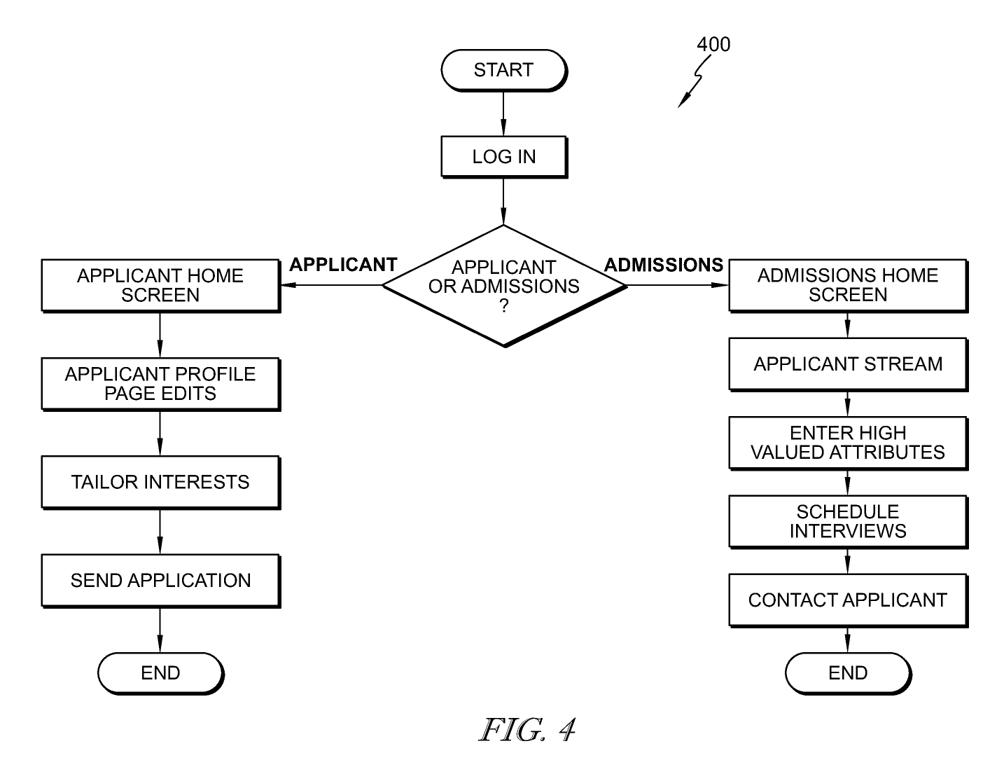

Referring now to FIG. 4, in some embodiments, admissions officers have web pages with rich media elements and are also able to view web pages of applicants that they are to meet with for an interview session or when meeting on campus or for a high school visit. For officers conducting tens of interviews a day, this may be a helpful tool to personalize each interview. It may additionally allow applicants to learn more about admissions officers before their visit. The system includes a two-tier profile system 400: one tier for applicants and one tier for admissions. Both tiers present information in a standardized manner so that members of either tier may digest information of the other tier.

The present disclosure allows college admissions representatives the ability to connect with applicants before their arrival for a school visit. This allows them to view the profile web pages of applicants entering their sessions and learn their backgrounds, interests, and passions. It also may enable applicants to learn more about the admissions officer visiting their school via the officer's personal profile page. The applicant may be able to see what impresses the given interviewer so that each applicant may prepare for their interviews more diligently.

### Crowd Sourced Personality Profile

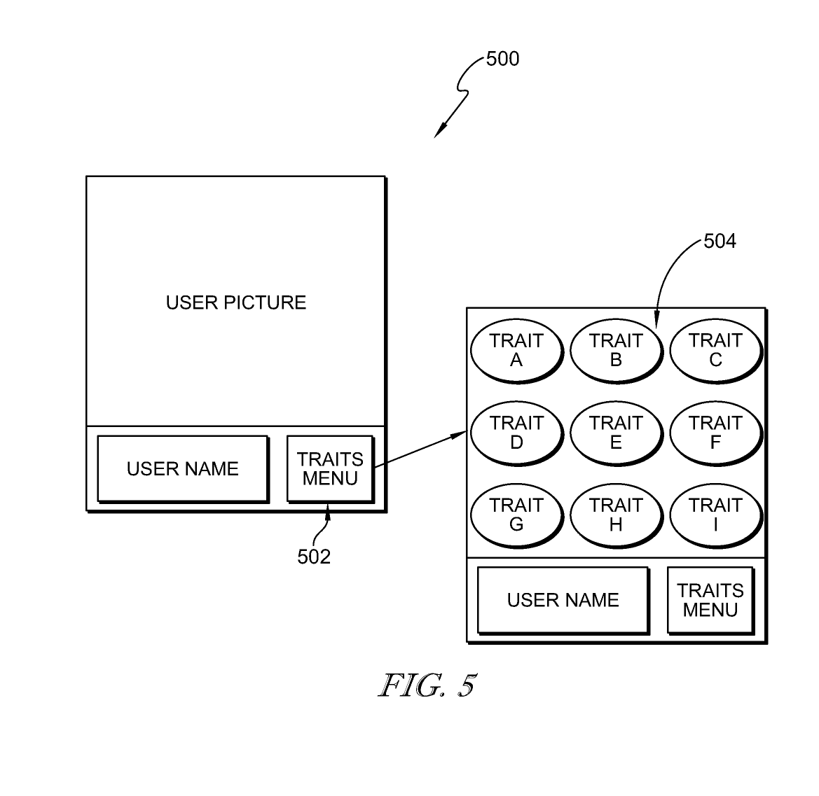

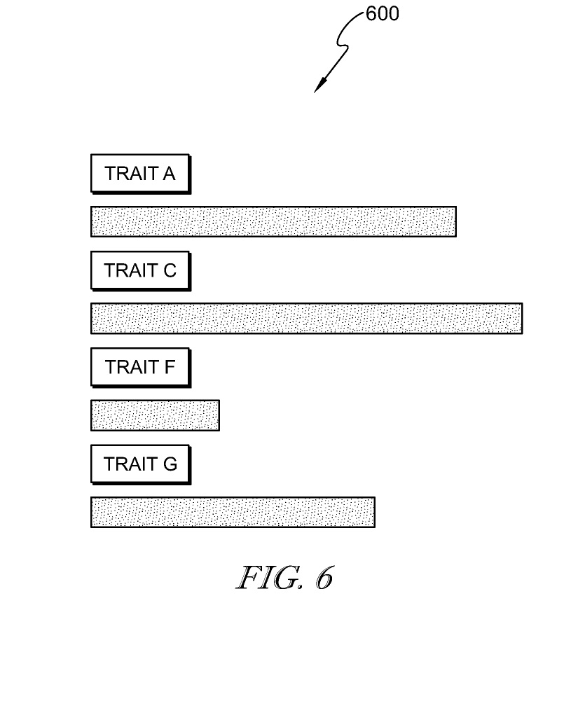

Referring now to FIGS. 5 and 6, crowd sourced endorsement profiles 500 are built for applicants based upon other community members validating a preselected set of traits for that applicant. In some embodiments, the endorsement profile information is stored on the system and displayed on the web page of the applicant. Other community members comprise other applicants, students, teachers, or counselors. This platform allows applicants to showcase their personality traits to colleges through other user's endorsements, which provides more validation to what the applicant claims.

In one embodiment, a member of the community visits an applicant's profile and clicks on the traits icon 502. The traits icon brings up a list of preselected traits 504. The community member then clicks on the traits associated with the given applicant the community member visited. The applicant then receives an email alerting that applicant that a community member boosted the given trait count. The applicant follows an email link to the applicant's profile to find out which community member and for what.

Once a suitable number of members of the community have boosted the preselected traits a crowd sourced personality profile is built by the community of the given applicant. The personality profile is displayed as a trait histogram 600, or other suitable graphical portrayal as shown in FIG. 6. Visitors to a user's profile web page are able to drill down into each trait and see the community members who boosted that trait.

To prevent community abuse of the system, trait boosting from community members who give a large number of boosts to a particular person are worth less in each preselected trait category than trait boosts from community members who are very selective with trait boosting. In this way, the real characteristics will tend to show through, regardless of community trait swapping schemes. In certain embodiments, trait boosting from an applicant's teachers have additional value over another applicant user. To enable this, a third, verified “teacher” type profile is generated for teacher's users.

In other words, if A gives B every single trait possible, then A's trait boosting for B are valued at or near 0. If instead A gives B only two trait boots, each of those two add value to B's score in each category. If A is B's teacher, then trait boosts have a high value. There is also boosting dilution to the value based on total trait boots given by a community member across the whole community.

In a scheme where custom traits are boosted, to prevent abuse involving negative traits there is a white list and black list for possible custom traits and likely misspellings. When a trait is created that is not on either list, that new trait is human verified and applied to either the white list or the black list.

In some embodiments, a user has limited ability to provide trait boosts for themselves. Personal trait boosts are limited to a predetermined and limited number of trait choices. However, personal trait choices are subject to the least white list and black list moderation. Once a custom trait is generated for a given user, other community members are enabled to easily boost that custom trait.

In one embodiment, the traits or qualities of the applicant are boosted (sometimes called endorsed) by other members (sometimes called references). The illustrative system includes a controller including a processor and a memory. The memory has stored therein a plurality of instructions that when executed by the processor cause the controller to receive instructions to endorse an applicant from one of a plurality of references of the applicant. The processor identifies a classification of the reference of the applicant and displays a plurality of qualifications for the reference to endorse the applicant as possessing as suggested in FIG. 5. The processor receives instructions to endorse one of the displayed plurality of qualifications from the reference and then stores information associated with the reference and associated with the qualification endorsed by the reference on the memory. The processor transmits to a computing device coupled with the controller the qualifications of the applicant that have been endorsed by the plurality of references, a weighted value of each of the qualifications based on the classification of each reference that endorsed the qualification, and a name of the references that endorsed the qualification of the applicant.

In some embodiments, the memory is configured to store data associated with qualifications of a plurality of applicants and a plurality of references. The controller is configured to adjust the weighted value of the endorsements of each reference based on a number of qualifications that the reference has endorsed. In some embodiments, the controller displays a plurality of indicia and each indicium is associated with an endorsable qualification of the applicant as shown in FIG. 5. In the illustrative embodiment, the plurality of qualifications or traits include one or more of “business savvy”, “creative”, “driven”, “generous”, “humorous”, “leader”, “outgoing”, “problem solver”, and “team player”. The indicia includes one or more of a briefcase, a paintbrush, a moving truck, a hand, a face, human silhouettes, a speech bubble, a calculator, and two fists associated with each of the qualifications respectively.

According to one illustrative embodiment, the present disclosure includes a platform for providing structured resumes for applicants to apply for admission into schools and colleges and to apply for scholarships. Rich media elements are incorporated on a web application to present a resume of the applicant and their qualities. Rich media elements may include pictures, video, text, links to documents, news stories, etc. In use, an applicant may include a link to their rich media profile web page in an application to a college or scholarship. In some cases, the present disclosure may also be integrated as a service into an online application platform.

According to another aspect of the disclosure, a method may include accepting, by a server, admissions agent profile specifications, the admissions agent profile specifications for determining preferred profile layouts; accepting, by the server, life data from an applicant, the life data describing accomplishments of the applicant; generating an applicant profile using the life data; and arranging the applicant profile to the admissions agent profile specifications.

According to another aspect of the disclosure, a method may include accepting, by the server, life data from an applicant, the life data describing accomplishments of the applicant; categorizing this life data into topics, the topics pertaining to pursuits and interests of the applicant; accepting an admissions goal from the applicant; grading the topics of life data with reference to the admissions goal; and generating an applicant profile using the life data having the highest grade with reference to the admissions goal.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A system useful in an outsource provider serving web pages offering scholastic opportunities, the system comprising:
(a) a computer store containing data for each of a plurality of first web pages and a plurality of second web pages;
(i) wherein each of the first web pages is associated with one of a plurality of applicants and each first web page includes a plurality of rich media elements;
(ii) wherein each of the second web pages is associated with one of a plurality of institutions;
(iii) wherein each of the second web pages displays an active link associated with a scholastic opportunity of a selected one of the plurality of institutions; and
(b) a computer server coupled to the computer store and programmed to:
(i) receive from a web browser of an applicant a signal indicating activation of an active link displayed by one of the second web pages;
(ii) automatically identify the scholastic opportunity associated with the activated link;
(iii) automatically identify a subset of the rich media elements included in the first web page associated with the applicant, the identified subset of rich media elements being indicative of qualifications of the applicant that are associated with the scholastic opportunity;
(iv) retrieve stored data corresponding to (A) the scholastic opportunity and (B) the identified subset of rich media elements in response to identification of the scholastic opportunity; and
(v) using the data retrieved, automatically generate and transmit to the selected institution a third web page that displays: (A) information associated with the scholastic opportunity associated with the link that has been activated and (B) the subset of the rich media elements.

2. The system of claim 1, wherein the selected institution, the outsource provider, and the applicant are each third parties with respect to one another.

3. The system of claim 1, wherein the subset of the rich media elements are indicative of at least one of a scholastic, athletic, and employment qualification of the applicant associated with the first web page.

4. The system of claim 3, wherein each of the first web pages is associated with a uniform resource identifier without ambiguous text characters.

5. The system of claim 4, wherein the computer server is further programmed to automatically identify qualifications of the applicant based on the plurality of rich media elements included in the first web page and display an active link associated with a scholastic opportunity of at least one of the second web pages on the first web page associated with the applicant in response to identifying the applicant's qualifications.

6. The system of claim 1, wherein the computer server is further programmed to organize the information displayed in the third web page into a predetermined layout in response to identification of the scholastic opportunity.

7. The system of claim 6, wherein the predetermined layout is selected by the selected institution.

8. The system of claim 7, wherein the computer server is further programmed to identify a plurality of first web pages having rich media elements associated with a designated qualification and transmit a fourth web page including active links to the plurality of first web pages having rich media elements associated with the designated qualification to one of the plurality of institutions.

9. The system of claim 1, wherein the computer server is further programmed to organize the information displayed in the third web page into a predetermined layout including a first rich media element, a second rich media element located below the first rich media element, and a third rich media element located below the second rich media element, the first rich media element includes a video of the applicant associated with the first web page, the second rich media element includes text and images associated with qualifications of the applicant associated with the first web page, and the third rich media element includes one or more of a video, text, document, image, and a graphics interchange format image indicative of the qualifications of the applicant associated with the first web page.

10. A system useful for serving online applications, the system comprising:
a computer store containing data for each of a plurality of first web pages, each of the first web pages being associated with one of a plurality of applicants, each of the first web pages includes a plurality of rich media elements indicative of qualifications of the applicant associated with the first web page, and each of the first web pages displays an active link associated with an application for admission into one of a selected plurality of institutions; and
a computer server coupled to the computer store and programmed to:
receive from a web browser of one of the applicants a signal indicating activation of the active link;
automatically identify the application for admission into the selected institution associated with the activated link;
automatically identify the applicant associated with the first web page;
automatically identify the rich media elements included in the first web page;
retrieve stored data corresponding to (A) the application for admission into the selected institution (B) the applicant associated with the first web page, and (C) the rich media elements included in the first web page in response to identification of the application for admission into the selected institution; and
using the data retrieved, automatically generate and transmit to the selected institution a second web page that displays: (A) information associated with the application associated with the link that has been activated, (B) information associated with the applicant associated with the first web page, and (C) the rich media elements included in the first web page.

11. The system of claim 10, wherein the computer server is further programmed to organize the information displayed in the second web page into a predetermined layout designated by the selected institution in response to identification of the application for admission into the selected institution associated with the activated link.

12. The system of claim 11, wherein the computer server is further programmed to receive from one of the selected plurality of institutions a designated qualification and to identify and provide a plurality of first web pages having rich media elements associated with the designated qualification to the selected institution.

13. The system of claim 12, wherein the computer server is further programmed to organize the information displayed in the second web page into a predetermined layout including a first rich media element, a second rich media element located below the first rich media element, and a third rich media element located below the second rich media element.

14. The system of claim 13, wherein the first rich media element includes a video of the applicant associated with the first web page, the second rich media element includes text and images associated with qualifications of the applicant associated with the first web page, and the third rich media element includes one or more of videos, text, documents, images, and graphics interchange format images associated with qualifications of the applicant associated with the first web page.

15. A system comprising:
a controller including a processor and a memory, the memory having stored therein a plurality of instructions that when executed by the processor cause the controller to:
receive instructions to endorse an applicant from one of a plurality of references of the applicant;
identify a classification of the reference of the applicant;
display a plurality of qualifications for the reference to endorse the applicant as possessing;
receive instructions to endorse one of the displayed plurality of qualifications from the reference;
store information associated with the reference and associated with the qualification endorsed by the reference; and
transmit to a computing device coupled with the controller (A) the qualifications of the applicant that have been endorsed by the plurality of references, (B) a weighted value of each of the qualifications based on the classification of each reference that endorsed the qualification, and (C) a name of the references that endorsed the qualification of the applicant.

16. The system of claim 15, wherein the memory is configured to store data associated with (i) qualifications of a plurality of applicants and (ii) a plurality of references and the plurality of instructions further cause the controller to adjust the weighted value of the endorsements of each reference based on a number of qualifications that the reference has endorsed.

17. The system of claim 16, wherein the plurality of instructions further cause the controller to display a plurality of indicia and each indicium is associated with an endorsable qualification of the applicant.

18. The system of claim 17, wherein the plurality of instructions further cause the controller to block the applicant from endorsing qualifications of the applicant.

19. The system of claim 18, wherein the plurality of qualifications include one or more of business savvy, creative, driven, generous, humorous, leader, outgoing, problem solver, and team player.

20. The system of claim 19, wherein the indicia includes one or more of a briefcase, a paintbrush, a moving truck, a hand, a face, human silhouettes, a speech bubble, a calculator, and two fists.
